(19) United States
(12) Patent Application Publication
(10) Pub. No.: US 2015/0120505 A1
(43) Pub. Date: Apr. 30, 2015

(54) IN-STORE OMNICHANNEL INVENTORY EXPOSURE

(71) Applicant: International Business Machines Corporation, Armonk, NY (US)

(72) Inventors: Ajay Ashok Deshpande, Yorktown Heights, NY (US); Kimberly D. Hendrix, Yorktown Heights, NY (US); Herbert Scott McFaddin, Yorktown Heights, NY (US); Chandrasekhar Narayanaswami, Yorktown Heights, NY (US)

(73) Assignee: International Business Machines Corporation, Armonk, NY (US)

(21) Appl. No.: 14/213,199

(22) Filed: Mar. 14, 2014

Related U.S. Application Data
(60) Provisional application No. 61/897,922, filed on Oct. 31, 2013.

(51) Int. Cl. G06Q 30/06

(52) U.S. Cl. CPC G06Q 30/0623
USPC 705/26.61

(57) ABSTRACT

A method and system for dynamically analyzing information relating to a store to determine product information to show on a display during a period, and displaying product information on the display based on the analyzed information for the period.

The present application claims priority from U.S. Provisional Application No. 61/897,922, filed on Oct. 31, 2013, the disclosure of which is incorporated herein by reference.

### DESCRIPTION

### Field of the Invention

The present invention relates generally to the use of contextual and inventory data in determining what products are shown on a display. An exemplary aspect of the invention is a display wall that can display items carried by a particular store based on contextual and inventory data.

### BACKGROUND OF THE INVENTION

### Description of the Related Art

In general, people shop online or in-store. Currently, eighty-five percent of commerce is still conducted in-store, while the remaining fifteen percent is done online. However, the online portion of commerce continues to grow as a percentage of overall commerce.

Physical stores have fewer stock-keeping units (SKUs), which are generally each assigned to a different product, displayed in-store than online due to limited space in stores. For instance, a large department store may stock two hundred and fifty thousand SKUs in the store, but will have five hundred thousand SKUs located in a central depository or warehouse.

In addition, not all of the SKUs are displayed in the store due to different demands in different geographical regions and at different times. Another reason for the limited SKUs in-store is that sometimes stores have found it easier to enlist third party merchants via online market places. Thus, the number of SKUs that a retailer holds in a distribution warehouse is much greater than the number of SKUs that are be displayed in a store.

Some stores have offered services such as buying online and the picking up the merchandise in-store. In addition, stores have offered the ability to buy online and then ship the product from a store for faster delivery.

### SUMMARY OF THE INVENTION

In view of the foregoing and other exemplary problems, drawbacks, and disadvantages of the conventional systems, it is an exemplary feature of the present invention to provide broader exposure to an assortment of products to shoppers.

Another exemplary feature of the present invention is to provide a structure and method for dynamically displaying product information to consumers based on contextual data.

A first exemplary aspect of the present invention, to achieve the above features and objects, described herein is a method including dynamically analyzing information relating to a store and a customer to determine product information to show on a display during a period, and displaying product information on the display based on the analyzed information for the period. Additionally the display can provide methods for selecting displayed products, placing them in a cart, and ordering them. The display may also operate in advertising-only mode in which it displays relevant products and directs the shopper to an online or physical store to complete the shopping process.

Another exemplary aspect of the invention is a non-transitory computer readable storage medium tangibly embodying a program of machine-readable instructions executable by a digital processing apparatus to perform a method, the method including dynamically analyzing information relating to a store to determine product information to show on a display during a certain period, and displaying product information on the display based on the analyzed information for the certain period.

Another exemplary aspect of the invention is a system including a data source, a processor configured to receive contextual information from the data source and to determine product information to display based on the contextual information, and a display in communication with the processor and configured such that the display receives the product display information from the processor.

These features may provide broader exposure to an assortment of products to shoppers.

### BRIEF DESCRIPTION OF THE DRAWINGS

The foregoing and other purposes, aspects and advantages will be better understood from the following detailed description of exemplary embodiments of the invention with reference to the drawings, in which:

FIG. 1 illustrates an exemplary display system 1, according to an aspect of the invention;

FIG. 2 illustrates an exemplary method for utilizing a display system 1, according to an aspect of the invention; and

FIG. 3 illustrates a method 300 according to an exemplary aspect of the invention.

### DETAILED DESCRIPTION OF AN EXEMPLARY EMBODIMENT(S) OF THE INVENTION

As eighty-five percent of commerce occurs in store, it would be advantageous to be able to expose their customers to the full range of products while there and capture more business. Also, with the rise of online stores, it is important for conventional stores to enable customers to easily order products which are not available in store.

Displays may be used to impart information to customers regarding merchandise. The displays can be formed of a single display (e.g., a liquid crystal display (LCD)), multiple displays joined to form a large display, a projector type display, or any other visual displaying technology. For simplicity, all display types, singular and plural, will be referred to as a display or a display wall.

In some embodiments, a large display may be advantageous, as the larger displays can more easily show a range of products. Large displays may also be able to display a product in real size and allow easy viewing from a large area of a store.

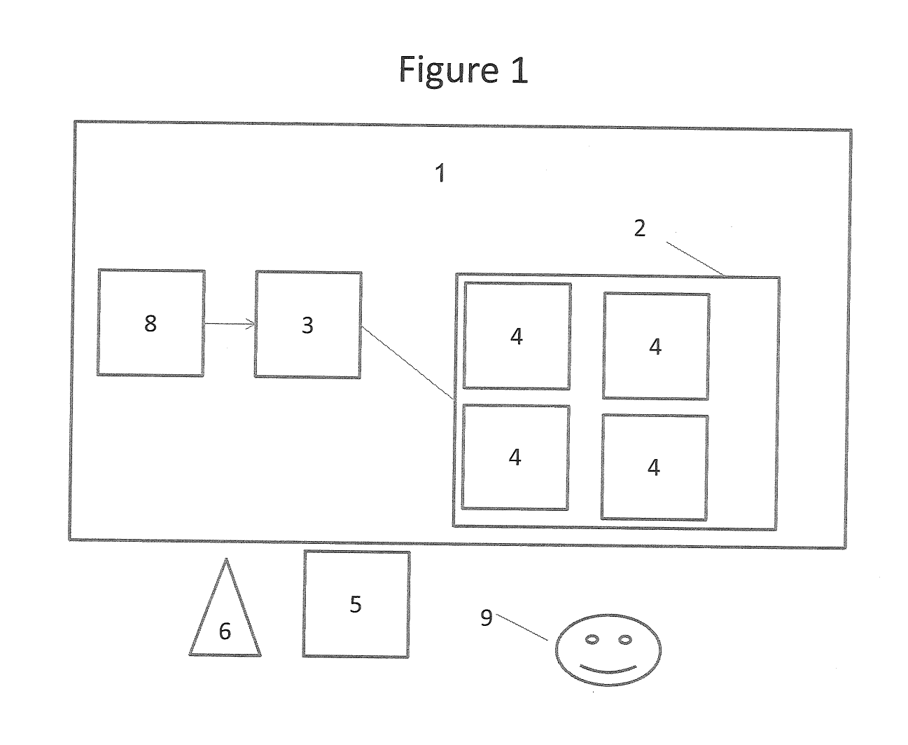

Referring now to the drawings, and more particularly to FIGS. 1-3, there are shown exemplary embodiments of the method and structures according to the present invention.

An exemplary display system 1 is illustrated in FIG. 1. The display system 1 contains a processor 3 and a display 2 that communicates with the processor. The processor 3 and display 2 may be located in the same location or may be remote from one another and communicate via wired or wireless systems. The display includes several display sections 4. Each display section 4 can be a separate display 2, or can be a portion of a single display 2.

An item order member 6 can be a physical or electronic token that captures the user's desire to purchase the product. If the token is physical, it may be located proximate to the display 2 or a physical product 5 and the customer takes it to the point of checkout in the store. The item order member 6 can then be read or scanned at the checkout point, paid for by the customer, and the product can then be shipped to the customer or store. If the token is logical, the item order member 6 could be a scannable code, image or electronic tag which the user can scan using a smart phone, store app, or store device, to allow the user to order the product online, or add the product to the customer's order as above. As another variation, the item order member 6 could be the image of the product information that is then scanned/imaged by the customer.

In an exemplary embodiment, the point of sale (e.g., a cashier) can synchronize with the shopper's online cart using id number, phone number, email, etc.

The display system 1 can be used to show a consumer products or information based on various forms of information used as data inputs. The information used to decide which items to display is not particularly limited. For example, the information can include any or all of the current time information, store information, customer information, and external condition information.

Examples of current time information can include any or all of time of day, date, day of week, day of year, holidays, events, etc.

Examples of store information can include geographic location, inventory in store, where products are located, products not carried in store, products which are out of stock, if a stocked product has variations or related products not available in the store, sales history of the store, the customers currently in the store, location of each customer in the store, which customer(s) is near/viewing the display, inventory of the stores or distribution centers in the surrounding area, location of the display (e.g., if in store or remotely located, and where the display(s) is located), etc.

Examples of customer information can include customer demographics, past customer transactions, customer profile information (birthday, age, gender, favorite color, etc.), recent customer online searches or interactions, customer social media, current customer location, historical customer locations by time, customer input, etc.

Examples of external conditions include current or historic traffic patterns, local events (e.g., sporting events, festivals, government events, religious events, etc.), weather, competitor locations, competitor promotions, public works events, etc.

Using the data inputs, the display system 1 can determine which information to display. The actual displayed information is not particularly limited and can include an image, an SKU, location, etc. The product information can be related to products in the store, available online, out of stock, in another store or distribution center, soon to be launched, etc.

The display receives input data, typically from a network, of which products to display. Because the input data is dynamic, the displayed images can be automatically changed based on the data inputs.

The structure of the input data is not particularly limited. For instance, if a display wall is formed of multiple displays, the display wall can be configured to act as a single display, receiving input data on what to display on each portion, or if the display wall is simple an collection of individual displays each connected to a network, each of the displays can receive different input data for that individual display.

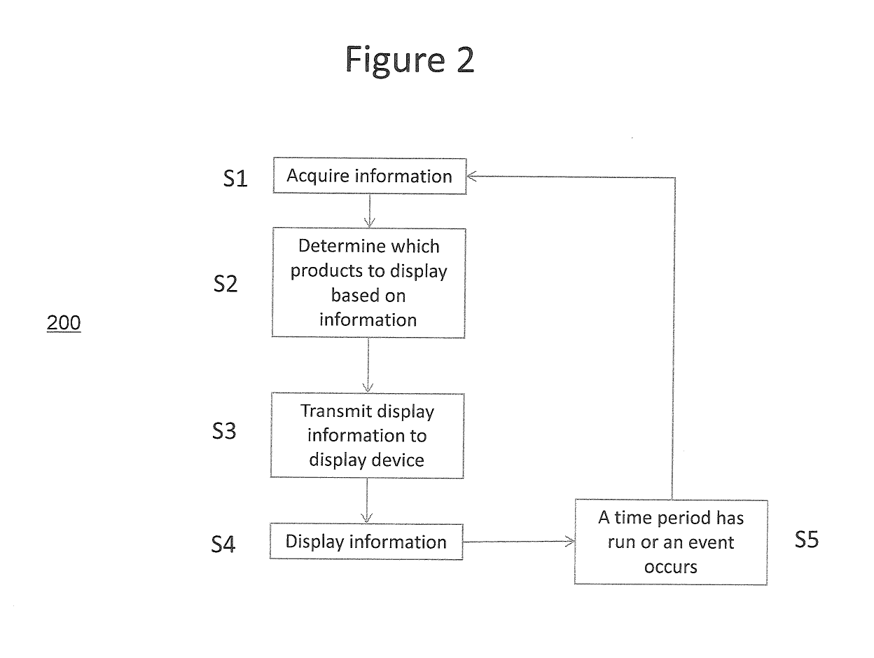

FIG. 2 illustrates an exemplary method 200 of the display system's operation. The processor 3 receives input data 8 having contextual information from one or more contextual information sources (S1). The processor 3 analyzes the information to determine which products would be best to display at a given time (S2). The method of analyzing the information is not particularly limited.

For example, a cognitive or learning machine can be used to produce a probability that a given product will be purchased at a specific time if shown on the display, based on a fusion of the various pieces of information, and use this information, along with other contextual information such as stock level of the product, to determine which products should be currently displayed.

Once the items to be displayed are selected, the processor transmits the display information to display 2 (S3). Display 2 will then display the selected items (S4). The processor 3 will update the analysis and display information over time (S5). The update performed by the processor can be time driven (e.g., every ten minutes) or event driven (e.g., a product runs out of stock or a customer walks within range of the display).

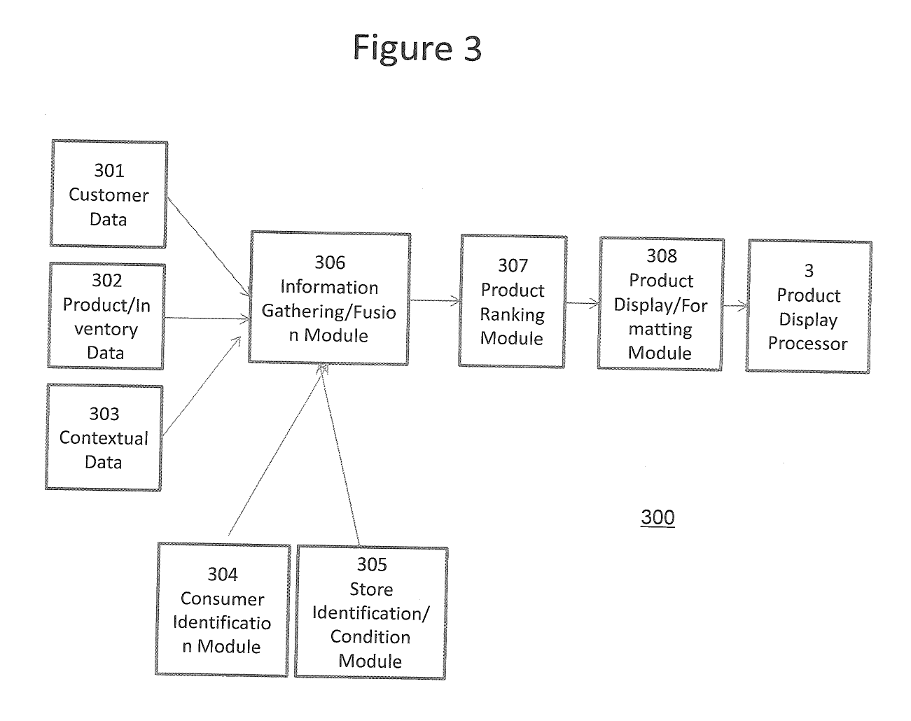

FIG. 3 illustrates a method 300 according to an exemplary embodiment of the invention. The method 300 may include a data gathering and decision making process. Module 304 and provides information about the customer near the display. This information may be determined by visually identifying the user or having the user scan an identifying token. In some cases the consumer identification module operates in anonymous mode or is attached to a camera and image recognition software that deduces a feature set about the user (age, gender, etc).

Module 305 provides information about the store setting where the display is posted, for example, the location in the store, nearby products or department, as well as overall information such as level of foot traffic.

Modules 304 and 305 provide their information to an information gathering and fusing module 306. In addition to the store context, this module receives inputs from information sources 301, 302, 303 providing customer data, product data and other contextual data as described above.

Module 306 fuses this data together, suggesting a list of products to be displayed to the user. Note that this information set may be greater than the capabilities of the display and the attention of the user; therefore it is channeled to a product-ranking module 307 that prioritizes the data to the display based upon various analytical strategies. Module 308 receives the prioritized data set and applies formatting and sizing methodologies, channeling the resulting product information to the product display processor described above.

The data driven display wall can be used in many different ways. For instance, if a customer visits a store to buy a particular item and it is not in-store, due to being out of stock or not carried in-store, the customer may see that product identified on an appropriate display wall as available online or out of stock. In an exemplary embodiment, out of stock items are automatically shown on the appropriate display. The customer may then interact with the display wall, obtain an order member (e.g., a barcode or token) which can be used at checkout, or use a store application, to purchase the item in question which then can be shipped from the distribution center to the customer or the store.

In an exemplary embodiment, the display system 1 displays items based on the time of day, day of the week, and prior sales history data. For instance, for a particular office supply store, it may be known that early afternoon is the time that most corporate supply personal visit the store. Therefore, the display system 1 can prioritize which products to display to suit this particular audience at the appropriate time. This may be combined with other data, such as out of stock or other not in-store items, to prioritize which products are displayed in on the display wall.

The input data can be pulled from any appropriate source. To acquire the various forms of information, the system 1 can be linked to online catalog systems, inventory systems, weather sources, traffic monitoring services, customer profiles and purchase histories, etc.

In an exemplary embodiment, the customers currently located in the store are be determined by wireless (e.g., Wi-Fi or Bluetooth) connection or mobile apps on a phone or other electronic device in the customer's possession. By using positioning technology, along with data on the individual customer (e.g., past purchases in a certain period, recent searches on a store website, demographics, etc.), the display system 1 will display an item that may be of interest to the customer on the nearest display wall.

By using past purchasing information in the input data, a customer who has bought an item such as a television in the last month will not be shown a television on the display, as it is unlikely they would purchase another in that time frame. However, in this example, items peripheral to a television (e.g. cables, connectors) may be shown on the display wall, as such purchases are more likely in that time period (e.g., a probability analysis or projection).

The input data can be used to generate a probability that the customer would purchase any particular item and then use that information to display the items the customer would most likely purchase. This result can also be weighted with other factors, such as if the item is currently located in store.

In an exemplary embodiment, the display system 1 shows different SKUs on the display (e.g., images and/or names of products). Out of stock items will automatically be displayed on the display. A large display, such as a display wall, can be located in a high traffic area of the store. This display can then show SKUs that are located in less traveled portions of the store. The display may also show products which have incentives offered by manufacturers or other promoters of the product.

Through the use of such technologies a customer can more easily find potential purchases and stores can increase customer spending.

Additionally, tracking the customer response when a product is displayed can form a feedback loop to identify which products the display is most useful for. Also, by tracking the resulting purchases some items can be added to store inventory and others can be marketed more aggressively online.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been described in terms of exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

1. A method, comprising:
dynamically analyzing, using a processor on a computer, information relating to a store to determine product information to show on a display during a period, the display being located in the store; and
displaying product information on the display based on the analyzed information for the period.

2. The method according to claim 1, further comprising accepting an order related to the displayed product information while a customer is in the store, based on the customer interacting with the display to obtain an order member, such as a physical or electronic token, a barcode, or an image of product information, to be used at a checkout point or with a store application.

3. The method according to claim 1, wherein the information includes at least one of current time information, store information, customer information, and external condition information.

4. The method according to claim 1, wherein the displaying product information is dynamically updated.

5. The method according to claim 3, wherein the store information includes at least one of geographic location, inventory in store, a location where products are located, products not carried in store, products which are out of stock, if a stocked product has variations or related products not available in the store, sales history of store, customers currently in store, location of customer in store, inventory of the stores in the surrounding area, and location of the display.

6. The method according to claim 3, wherein the current time information includes at least one of time of day, date, day of week, and day of year.

7. The method according to claim 3, wherein the customer information includes at least one of customer demographics, past customer transactions, customer profile information, recent customer online interactions, customer social media information, customer reviews, a current customer location, a historical customer location by time, customer-entered input, an identification of a specific customer in a vicinity of the display, and a recognition that a person is located in the vicinity of the display.

8. The method according to claim 3, wherein the external conditions include at least one of traffic patterns, local events, weather, competitor locations, and public works events.

9. A non-transitory computer readable storage medium tangibly embodying a program of machine-readable instructions executable by a digital processing apparatus to perform a method, the method comprising:
dynamically analyzing information relating to a store to determine product information to show on a display in the store during a certain period; and
displaying product information on the display based on the analyzed information for the certain period.

10. The non-transitory computer readable storage medium according to claim 9, the method further comprising:
receiving an input from a customer concerning product information on the display; and
providing at least one of additional information and an item order member related to the product information to permit the customer to purchase or place an order for an item while the customer is still in the store.

11-12. (canceled)

13. The non-transitory computer readable storage medium according to claim 11, wherein the store information includes at least one of geographic location, inventory in store, a location where products are located, products not carried in store, products which are out of stock, if a stocked product has variations or related products not available in the store, sales history of store, customers currently in store, location of customer in store, inventory of the stores in the surrounding area, and location of the display.

14. The non-transitory computer readable storage medium according to claim 11, wherein the current time information includes at least one of time of day, date, day of week, and day of year.

15-16. (canceled)

17. A system, comprising:
a data source;
a processor configured to receive contextual information from the data source and to determine product information to display based on the contextual information; and
a display located in the store and in communication with the processor and configured such that the display receives the product display information from the processor.

18. The system according to claim 17, wherein the processor is configured to receive a signal related to a product order from a customer while in a store in which the display is located.

19-20. (canceled)

21. The system according to claim 17, wherein the display comprises one of a plurality of display units located in the store and wherein each display unit can selectively present a different display.

22. The method according to claim 1, further comprising:
determining identification of one or more specific customers currently in the store;
retrieving and analyzing data on at least one of the one or more specific customers;
detecting current specific locations in the store of the at least one of the specific customers; and
presenting a display specifically oriented as an item possibly of interest to that specific customer when the specific customer is detected as near a display in the store, with the display being dynamically presented on a display nearest the specific customer's detected current location.

23. The method according to claim 1, further comprising tracking customer responses to displays of different products.

24. The method according to claim 1, wherein the dynamically analyzing comprises:
calculating a probability that a given product would be purchased during a specific time period if shown on the display;
retrieving information on a current stock level of the product; and
providing product information for the given product during the specific time period.

25. The method according to claim 1, wherein the dynamically analyzing and displaying is updated in at least one of a periodic update and an event driven update.

26. The method according to claim 25, wherein an event driven update occurs if a customer is detected as walking within a range of a display in the store.
